(19) United States
(12) Patent Application Publication
(10) Pub. No.: US 2013/0097417 A1
(43) Pub. Date: Apr. 18, 2013

(54) SECURE PRIVATE COMPUTATION SERVICES

(71) Applicants: Kristin Estella Lauter, Redmond, WA (US); Michael Naehrig, Stolberg (DE); Vinod Vaikuntanathan, Toronto (CA)

(72) Inventors: Kristin Estella Lauter, Redmond, WA (US); Michael Naehrig, Stolberg (DE); Vinod Vaikuntanathan, Toronto (CA)

(73) Assignee: MICROSOFT CORPORATION, Redmond, WA (US)

(21) Appl. No.: 13/272,447

(22) Filed: Oct. 13, 2011

(51) Int. Cl. H04L 9/00

(52) U.S. Cl. 713/150

(57) ABSTRACT

An encryption scheme allows meaningful, efficient computation of encrypted data in various application domains, including without limitation patient health care, financial analysis, market research, and targeted advertising. Data providers, computational services, and results consumers work in concert using a somewhat homomorphic encryption scheme to preserve the secrecy while providing practical computational performance. Encrypted data is stored within network-accessible storage. The data is encrypted using an encryption scheme that allows predictive analysis on the encrypted data without decrypting the encrypted data. The predictive analysis includes evaluation of polynomials of bounded degree on elements of the encrypted data. The evaluation includes ciphertext addition compositions and a bounded number of ciphertext multiplication compositions. The predictive analysis is performed on the encrypted data without decrypting the encrypted data to create encrypted results, which are transmitted to an entity possessing a decryption key capable of decrypting the encrypted results.

### BACKGROUND

The development of cloud storage and services (sometimes referred to as “utility computing services”) has allowed users to offload both storage of their data and associated computations on that data. As a result, businesses can choose to forego the expensive proposition of maintaining their own data centers, relying instead on cloud storage and computational services. However, concerns over the loss of privacy (e.g., the loss of the value of private data and computation) present significant challenges to the adoption of cloud services by consumers and businesses alike. Accordingly, many cloud storage solutions employ a level of encryption on the user's data to preserve data privacy. Unfortunately, it is difficult to efficiently perform meaningful computations on encrypted data without decrypting the data first. As such, substantial privacy concerns remain.

### SUMMARY

Implementations described and claimed herein address the foregoing problems by providing an encryption scheme that allows meaningful, efficient computation on encrypted data. Further, the data providers, computational services, and results consumers work in concert using a somewhat homomorphic encryption scheme to preserve the secrecy while providing practical computational performance. For example, a user's data is transmitted and stored in the cloud in an encrypted format that allows meaningful computations to be performed on the data, without decrypting the data, and the computational constraints for a given application domain allow acceptable computational performance by a cloud-based computational service.

In one implementation, encrypted data is stored within network-accessible storage. The data is encrypted using an encryption scheme that allows predictive analysis on the encrypted data without decrypting the encrypted data. The predictive analysis includes evaluation of polynomials of bounded degree on elements of the encrypted data. The evaluation includes ciphertext addition compositions and a bounded number of ciphertext multiplication compositions. The predictive analysis is performed on the encrypted data without decrypting the encrypted data to create encrypted results, which are transmitted to an entity possessing a decryption key capable of decrypting the encrypted results.

In some implementations, articles of manufacture are provided as computer program products. One implementation of a computer program product provides a tangible computer program storage medium readable by a computing system and encoding a processor-executable program. Other implementations are also described and recited herein.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example environment providing secure private computation services on data encrypted using a data provider's private key.

FIG. 2 illustrates example operations for providing secure private computation services using a data provider's private key.

FIG. 3 illustrates an example environment providing secure private computation services on data encrypted using a results consumer's public key.

FIG. 4 illustrates example operations for providing secure private computation services on data encrypted using a results consumer's public key.

FIG. 5 illustrates an example environment providing secure private computation services on data using a public key of a user acting as both a data provider and a results consumer.

FIG. 6 illustrates example operations for providing secure private computation services on data using a public key of a user acting as both a data provider and a results consumer.

FIG. 7 illustrates an example system that may be useful in implementing the technology described herein.

### DETAILED DESCRIPTION

One method of maintaining the secrecy of a user's data in a cloud-based computational environment is to store all data in an encrypted format and to perform the computations on the encrypted data, without decrypting the data first. However, previous approaches have proven to be intractable. In contrast, technology described herein provides practical schemes for offloading storage and computation of secret data without decrypting the data by supporting a bounded number of ciphertexts multiplication compositions in combination with a potentially very large number of ciphertext addition compositions. Generally, the term “ciphertext” refers to an encrypted data set (e.g., an encrypted message, an encrypted data bit, encrypted text, etc.). For certain selected applications, a somewhat homomorphic encryption (SwHE) scheme, which allows a bounded number of ciphertext multiplication compositions, provides improved efficiency improvements over fully homomorphic approaches.

In one example application, that of a cloud service for managing electronic medical records (EMR), a potential scenario exists in which many devices continuously or periodically measure and/or collect vital health information about a user (e.g., a patient). The devices stream the health information to a computation system, which can reside in the cloud or within an arbitrary communications network. Over time, the computation system can compute statistics over the collected health information and provide useful feedback pertaining to the care of the patient. For example, the statistics may suggest a change in a course of treatment (e.g., a change in a medicine dosage). Accordingly, the computational system may send an alert to the patient or his or her caregiver to adjust the dosage.

Typically, in such scenarios, the volume of collected data is large and the user would prefer not to store the data locally, thereby suggesting a role for cloud storage. Accordingly, to protect patient privacy within the cloud storage environment, the health information is uploaded to cloud storage in encrypted form. The computational system performs operations on the encrypted health information and returns feedback in the form of encrypted alerts, predictions, recommendations, and/or summaries of the results to the patient or his or her caregiver. Other example applications represent variations of this theme and are detailed below.

Before turning to example implementations in specific application domains (e.g., healthcare, financial analysis, advertising), an introduction of the somewhat homomorphic encryption (SwHE) scheme is warranted. The SwHE scheme, represented by the expression SHE=(SH.Keygen, SH.Enc, SH.Add, SH.Mult, SH.Dec), is associated with a number of parameters:
the dimension n, which is a power of 2;
the cyclotomic polynomial ƒ(x)=xⁿ+1;
the modulus q, which is a prime number such that q≡1(mod2n) (together, n, q, and ƒ(x) define rings R=Z|x|/ [symbol] ƒ(x) [symbol] and R_{q}=R/qR=Z|x|/ [symbol] ƒ(x) [symbol] );
the error parameter σ, which defines a discrete Gaussian error distribution χ=D_{Z}_{ⁿ}_{, σ} with a standard deviation σ;
a prime number t<q, which defines the message space of the scheme as Rₜ=Z|x|/ [symbol] ƒ(x) [symbol] , the ring of integer polynomials modulo ƒ(x) and t; and
a number D>0, which defines a bound on the maximum number of multiplications that can be performed correctly using the scheme.

In one implementation, the SwHE scheme is a function of the following component operations:
SH.Keygen(1^{K}): a key generation operation, which in one implementation includes (1) sampling a ring element s [symbol] χ, (2) defining a secret key sk=s , (3) sampling a uniformly random ring element a₁←R_{q} and an error e←χ, and (4) computing a public key pk=(a₀=−(a₁s+te),a₁);
SH.Enc(pk,m): an encoding operation, which in one implementation includes: (1) encoding the message m as a degree n polynomial with coefficients in Zₜ—given the public key pk=(a₀,a₁) and a message m ∈ R_{q} , the encryption algorithm samples u←χ and ƒ,g←χ, and (2) computing the ciphertext ct=(c₀, c₁)=(a₀u+tg+m,a₁u+tƒ); and
SH.Dec (sk,ct=(c₀,c₁, . . . , c_{δ})): a decryption operation, which in one implementation includes: (1) decrypting by computing

$$\tilde{m} = {\sum }_{i = 0}^{δ} {c}_{i} {s}^{i} ∈ {R}_{q} ,$$

and (2) outputting the message as \tilde{m}(modt).

In addition, the SwHE scheme is a function of a couple of homomorphic operations SH.Add and SH.Mult. In one implementation, in order to homomorphically compute an arbitrary function ƒ, an arithmetic circuit for ƒ (made of addition and multiplication operations over Zₜ) may be constructed. The SH.Add and SH.Mult operations are used to iteratively compute f on encrypted inputs. Although the ciphertexts produced by SH.Enc contain two ring elements, the homomorphic operations increase the number of ring elements in the ciphertext. In general, the SH.Add and the SH.Mult operations get as input two ciphertexts ct=(c₀,c₁, . . . , c_{δ}) and ct′=(c₀′,c₁′, . . . ,c_{γ}′). The output of SH.Add contains max (δ+1, γ+1) ring elements, whereas the output of SH.Mult contains δ+γ+1 ring elements.
SH.Add(pk,ct₀,ct₁): Let ct=(c₀,c₁, . . . ,c_{δ}) and ct′=(c₀′,c₁′, . . . ,c_{δ}′) be two ciphertexts. Assume that δ=γ, otherwise, pad the shorter ciphertext with zeroes. Homomorphic addition is accomplished by component-wise addition of the ciphertexts. Namely, compute and output

$${ct}_{add} = ( {c}_{0} + {c}_{0}^{′} , {c}_{1} + {c}_{1}^{′} , … , {c}_{max ( δ , γ )} + {c}_{max ( δ , γ )}^{′} , ) ∈ {R}_{q}^{max ( δ , γ )}$$

SH.Mult(pk,ct₀,ct₁): Let ct=(c₀,c₁, . . . ,c_{δ}) and ct′=(c₀′,c₁′, . . . ,c_{γ}′) be two ciphertexts. Let v be a symbolic variable and consider the expression

$$( {\sum }_{i = 0}^{δ} {c}_{i} {v}^{i} ) \cdot ( {\sum }_{i = 0}^{γ} {c}_{i}^{′} {v}^{i} ) over {R}_{q} , \qquad ( 1 )$$

Expression (1) can be decomposed by symbolically treating v as an unknown variable to compute ĉ₀, . . . ,ĉ_{δ+λ} ∈R_{q} such that for all v ∈ R_{q}

$$( {\sum }_{i = 0}^{δ} {c}_{i} {v}^{i} ) \cdot ( {\sum }_{i = 0}^{γ} {c}_{i}^{′} {v}^{i} ) ≡ {\sum }_{i = 0}^{δ + γ} {\hat{c}}_{i} {v}^{i} \qquad ( 2 )$$

The output ciphertext is ctₘᵤₗₜᵢ=(ĉ₀, . . . ,ĉ_{δ+γ}).

Accordingly, given the mathematical foundation above, the described technology applies an SwHE scheme to provide predictive analysis including evaluation of polynomials of bounded degree on elements of encrypted data. Generally, predictive analysis uses computational tools, often statistical tools including modeling, data mining, game theory, etc., to analyze data to make predictions about future events, trends, values, etc. In one implementation, predictive analysis employing statistical computations, such as an average, a standard deviation, and a logistical regression, among other computations, may be performed:
Average of n terms {cᵢ}: returned as a pair (Σ_{i=l, . . . , n}cᵢ, n), where is

$$m = \frac{{\sum }_{i = 1 , … , n} {c}_{i}}{n}$$

is the average
Standard deviation:

$$\sqrt{\frac{{\sum }_{i = 1 , … , n} {( {c}_{i} - m )}^{2}}{n}} ,$$

returned as a pair that consists of the numerator and denominator of the expression before taking the square root
Logistical regression: x=Σ_{i=1, . . . ,n}αᵢxᵢ, where α₁ represents the weighting constant or regression coefficient for the variable xᵢ, and the prediction is

$$f ( x ) = \frac{{e}^{x}}{1 + {e}^{x}}$$

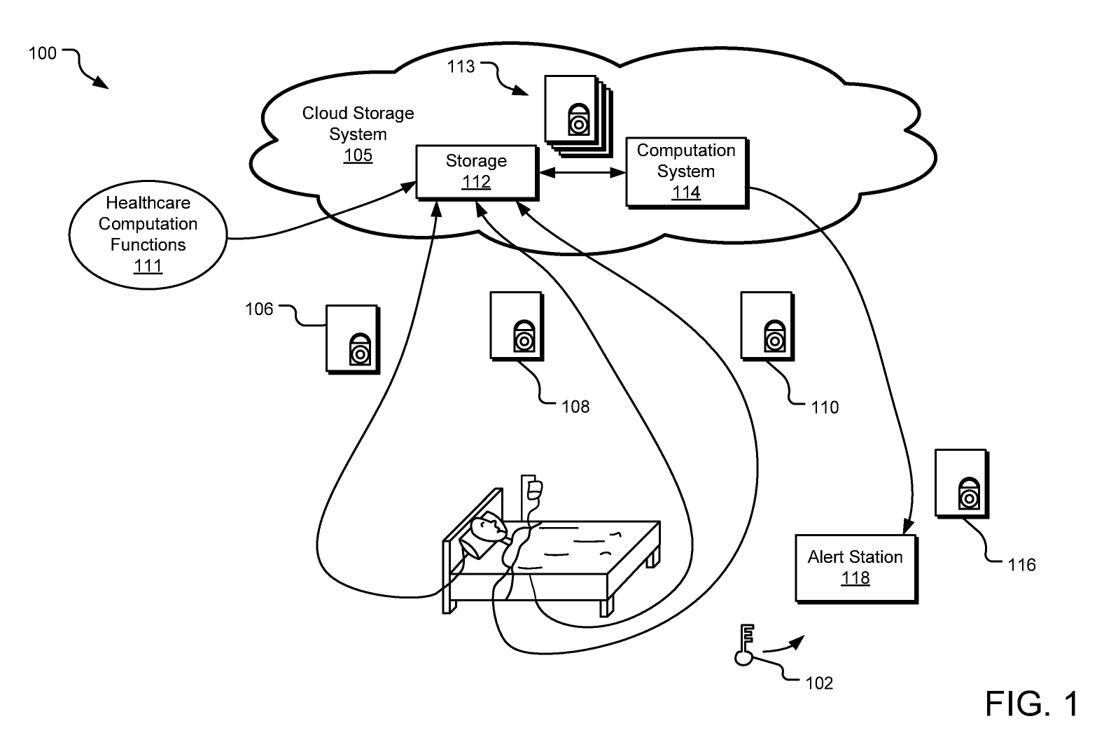

FIG. 1 illustrates an example environment 100 providing secure private computation services on data encrypted using a data provider's private key 102, although in an alternative implementation, public key encryption may be employed. In the example environment 100, the data provider is an entity represented by a patient 104 who is being monitored by various healthcare-monitoring devices (not shown) within a private cloud medical records storage system. The monitoring devices are communicatively coupled a communication network (e.g., coupled to a “cloud” storage system 105) to collect and encrypt data pertaining to a patient's medical record before uploading the patient's data to the patient's record in the cloud storage system 105. The patient (and/or his or her caregiver) controls his or her private encryption key(s) and, therefore, controls access to his or her data. For example, the patient may share a private key 102 with one or more specific healthcare providers, who load the patient's private key into the monitoring devices. The packets 106, 108, and 110 represent patient data being uploaded in an encrypted format (as represented by the padlock on each packet) to the cloud storage system 105. It should be understood that although the uploaded data is represented in FIG. 1 as a packet or a package of data, the monitored data would typically be streamed to the cloud storage system 105 in an encrypted format, although some implementations may collect a data stream into a data set before uploading it to the cloud storage system 105. One or more storage devices 112 reside within the cloud storage system 105 to receive the uploaded data 106, 108, and 110. Such storage 112 may physically or logically reside within a single location or organization, or the storage 112 may be distributed.

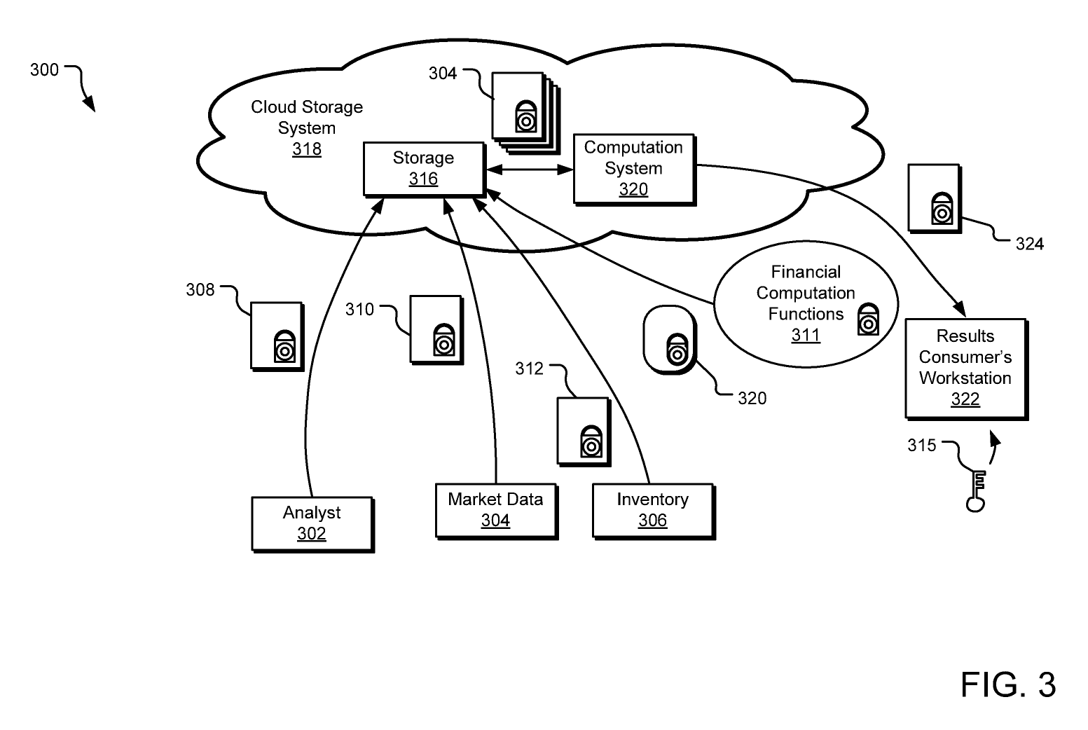

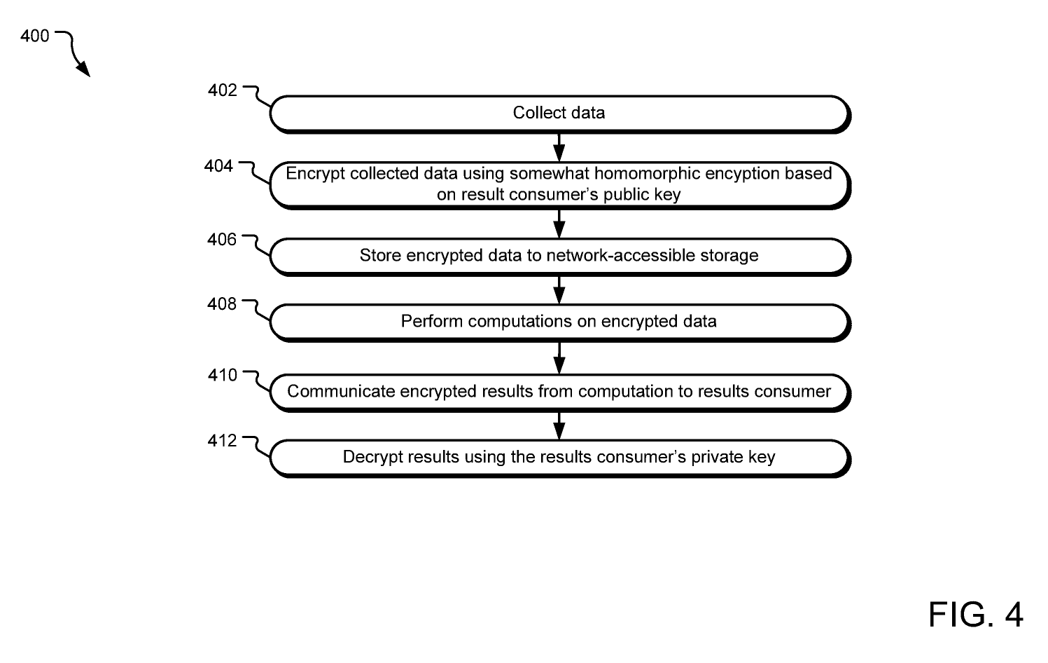

Furthermore, using an implementation of the SwHE scheme, the cloud storage system 105 may also perform computations on the uploaded encrypted data on behalf of the patient without decrypting the data itself In the scenario illustrated in FIG. 1, various healthcare computation functions 111 are uploaded to the cloud storage system 105. A computation system 114 accesses the healthcare computation functions and the encrypted data 113 in the storage 112 of the cloud storage system 105 and performs the computations on the encrypted data without breaching secrecy of the encrypted data. In response to these computations, the computation system 114 (and/or the storage 112) sends to the patient various updates, alerts, predictions, or recommendations (collectively shown as encrypted alert 116) based on the results of the computations. Example computations that may be performed in this scenario include without limitation averages, standard deviations, and other statistical functions, such as logistical regressions that can help predict the likelihood of certain dangerous health episodes. Encrypted input to the computation functions may include blood pressure readings, heart monitor data, blood sugar readings, for example, along with information about the patient, such as age, weight, gender, and other patient parameters. Typically, the computations performed in this scenario need not be private as they tend to be a matter of public health and are therefore in the public domain. Nevertheless, the computations themselves may be kept private, such as in the scenario described with regard to FIGS. 3 and 4. The encrypted alert 116 can be received and decrypted (e.g., using the patient's private key 102) by various monitoring and/or dosage devices, by an alert station 118 that provides a user interface to the alert information, or by other healthcare systems.

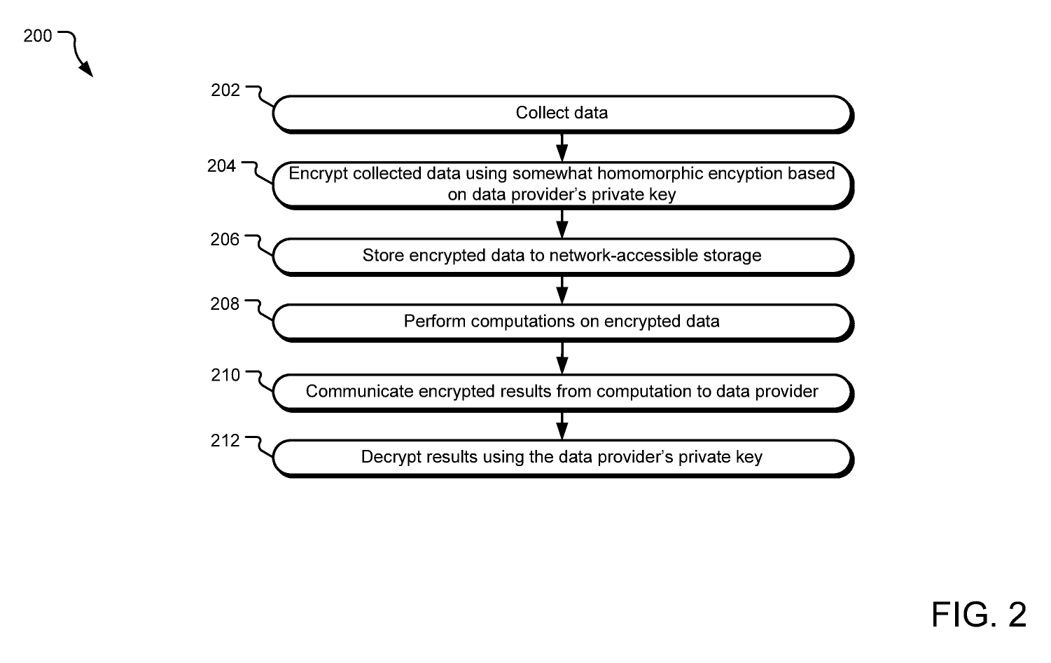

FIG. 2 illustrates example operations 200 for providing secure private computation services using a data provider's private key. A collecting operation 202 collects data associated with a data provider, such as a patient, a business, or other user or system. For example, the collecting operation 202 may collect data from monitoring devices, such as a blood pressure reader, heart monitor, a thermometer, etc., from an image datastore, such as an imaging database containing a patient's MIR results, and from other data sources. In many scenarios, the collected data is in the form of a data stream, although discrete data sets, such as images, patient records, etc. may also be collected.

An encryption operation 204 encrypts the collected data using somewhat homomorphic encryption (SwHE) based on a private key of the data provider. A storing operation 206 uploads the encrypted data to network-accessible storage, such as a cloud storage system. While the encrypted data is stored in the network-accessible storage, it remains encrypted.

A computation operation 208 performs addition and multiplication computations on the encrypted data within the network-accessible storage without decrypting the data. Typically, the computation functions are provided to the network-accessible storage from a function database or service. In one implementation, the computation functions include a number of additions operations and a fixed set of multiplication operations. A communication operation 210 communicates the encrypted results, which remain encrypted based on the data provider's private key, from the computations to the data provider. A decryption operation 212 decrypts the results using the data provider's private key.

FIG. 3 illustrates an example environment 300 providing secure private computation services on data encrypted using a results consumer's public key. In the financial industry, there are potential application scenarios in which both the data and the function to be computed on the data are private and proprietary. As an example, confidential data about the company, its stock price, its performance, and its inventory is often relevant to making investment decisions. Data from a data providing entity may be streamed on a continuous basis reflecting the most up-to-date information necessary for making decisions for trading purposes. Such a company may also employ proprietary computations in analyzing its business, for example, based on new predictive models for stock price performance. As these proprietary computations may be the product of costly research done by financial analysts. Accordingly, the company may want to maintain the secrecy of these models to preserve the company's advantage and its investment.

In the example environment 300, one or more data providers are represented by an analyst 302, a market data source 304, and an inventory system 306. Each data provider encrypts its data 308, 310, or 312 using a public key associated with the results consumer entity, such as the CEO of a company. The encrypted data 308, 310, and 312 is uploaded to one or more storage devices 316 of a cloud storage system 318. In addition, financial computation functions 311 are also encrypted using a public key of the results consumer and uploaded as encrypted functions 320 to the one or more devices 316 in the cloud storage system 318. It should be understood that although the uploaded data 308, 310, and 312 and encrypted functions 320 are represented in FIG. 3 as packets or packages of data, the uploaded data would typically be streamed to the cloud storage system 318 in an encrypted format, although some implementations may collect a data stream into a data set before uploading it to the cloud storage system 318.

In this manner, the results consumer controls his or her private encryption key(s) and, therefore, controls access to both the data 308, 310, and 312 and the encrypted functions 320. A computation system 320 of the cloud storage system 318 can execute the computations within the SwHE scheme without decrypting either the data 308, 310, or 312 or the encrypted functions 320.

In the scenario illustrated in FIG. 3, a computation system 320 accesses the encrypted data 308, 310, and 308 in the storage 316 of the cloud storage system 318 and performs computations on the encrypted data without breaching secrecy of the encrypted data. In response to these computations, the computation system 320 (and/or the storage 316) sends to the results consumer various analysis results (collectively shown as encrypted results 324) based on the results of the computations. Example computations that may be computed in this scenario include without limitation averages, standard deviations, and other statistical functions, such as logistical regressions that can help predict the likelihood of certain financial events. It should be understood that some of the data (e.g., publicly available stock market data) and computations (e.g., simple averages) employed in the scenario depicted in FIG. 3 may not be considered secret or proprietary and therefore may not be encrypted. The encrypted results 322 can be received and decrypted (using the results consumer's private key 315) by the result consumer's workstation 322 or some other device that can provide access to the decrypted results.

FIG. 4 illustrates example operations 400 for providing secure private computation services on data encrypted using a results consumer's public key. A collecting operation 402 collects data associated with a data provider entity, such as an inventory system, a financial analyst, a financial database, or other user or system. For example, the collecting operation 402 may collect inventory data from an MRPII inventory management system, stock price data from a stock quote ticker system, and other data from other users and data sources. In many scenarios, the collected data is in the form of a data stream, although discrete data sets, such as images, company profiles records, etc. may also be collected.

An encryption operation 404 encrypts the collected data using somewhat homomorphic encryption (SwHE) based on a public key of the results consumer, such as a CEO of a company. A storing operation 406 uploads the encrypted data to network-accessible storage, such as a cloud storage system. While the encrypted data is stored in the network-accessible storage, it remains encrypted.

A computation operation 408 performs addition and multiplication computations on the encrypted data within the network-accessible storage without decrypting the data. An example computation may predict a stock price or a product sales amount. Typically, the computation functions are provided in encrypted form (e.g., using the results consumer's public key) to the network-accessible storage from a function database or service and may be private and proprietary computation functions. In one implementation, the computation functions include a number of additions operations and a fixed set of multiplication operations. A communication operation 410 communicates the encrypted results, which remain encrypted based on the results consumer's public key, from the computations to the results consumer. A decryption operation 412 decrypts the results using the results consumer's private key.

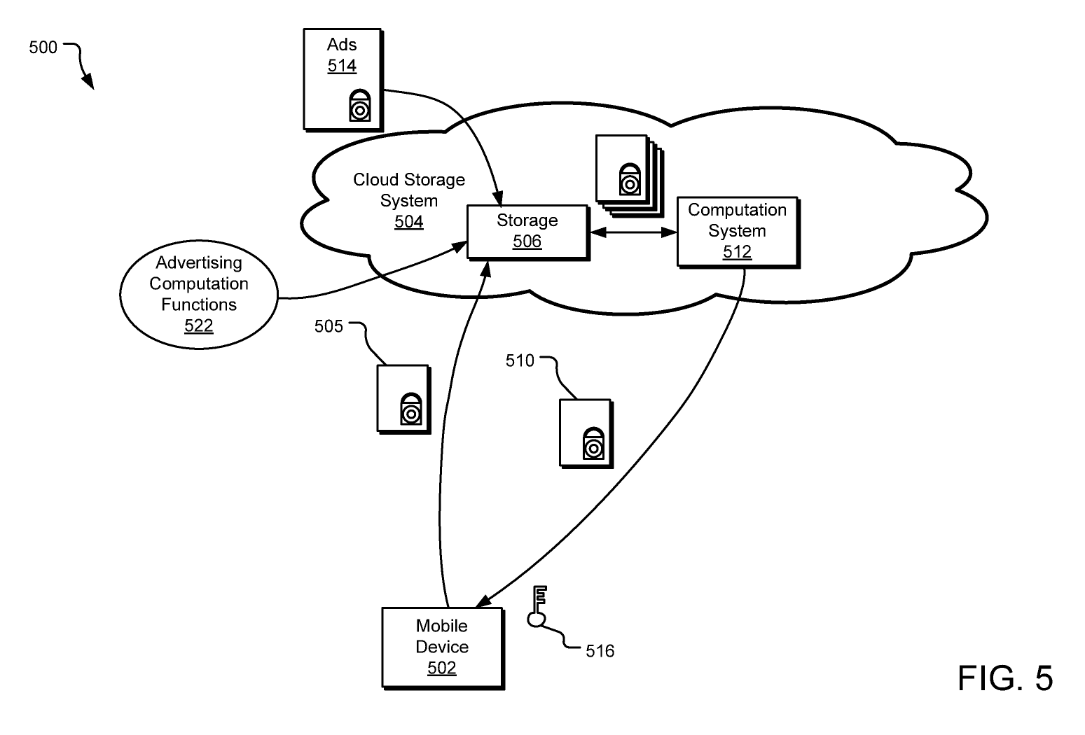

FIG. 5 illustrates an example environment 500 providing secure private computation services on data using a public key of a user acting as both a data provider and a results consumer. For example, in commercial settings, an advertising company may wish to use contextual information about consumers in a demographic to target advertising toward those potential customers. As such, a consumer using a mobile phone 500 as a computing device may continuously encrypt (using his or her public key) and upload to one or more storage devices 506 of a cloud storage system 504 certain contextual information 505 about himself or herself, including without limitation location, time of day, information from e-mail or browsing activity, such as keywords from e-mail or browser searches, etc. When the encrypted contextual information 505 is uploaded to the cloud storage system 504 and made accessible to the company, the advertising company can employ a computation system 512 to execute certain public or secret computations functions 522 against the encrypted contextual information 505 and determine an appropriate targeted advertisement 510 to send back to the customer's mobile device 502.

Using SwHE, the consumer can encrypt the contextual information 505 before uploading it to the cloud storage system 504, thereby protecting against privacy breaches. In addition, the advertising company uploads ads 514 to the cloud storage system 504. The computation system 512 computes one or more functions on the encrypted contextual data stored in the storage 506 to determine which ads 514 to encrypt and send to the consumer. The selected ads 510 and any contextual information in the ads 510 are encrypted to the consumer's public key. Accordingly, consumer can decrypt the received, encrypted ad 510 using his or her private key 516.

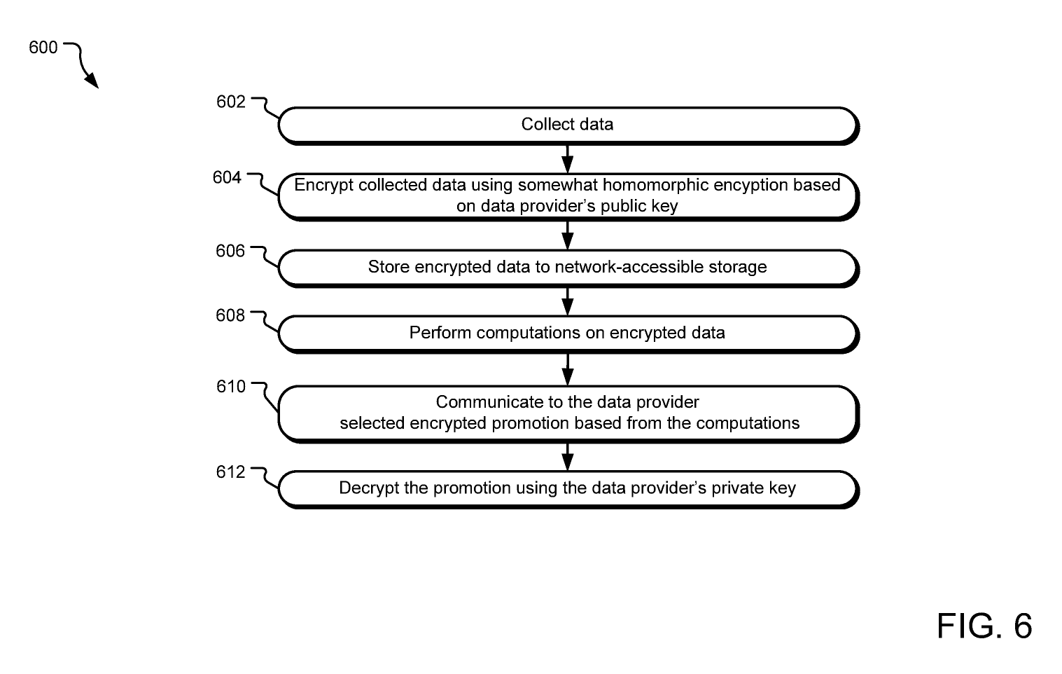

FIG. 6 illustrates example operations 600 for providing private services on data using a source user's public key. A collecting operation 602 collects data associated with a data provider entity, such as a consumer or other user or system. For example, the collecting operation 602 may collect location data, browser history data, mobile purchase data, and other data from the consumer and other users. In many scenarios, the collected data is in the form of a data stream, although discrete data sets, such as images, company profiles records, etc. may also be collected.

An encryption operation 604 encrypts the collected data using somewhat homomorphic encryption (SwHE) based on a public key of the data provider. A storing operation 606 uploads the encrypted data to network-accessible storage, such as a cloud storage system. While the encrypted data is stored in the network-accessible storage, it remains encrypted.

A computation operation 608 performs addition and multiplication computations on the encrypted data within the network-accessible storage without decrypting the data. An example computation may select an advertisement or coupon to be presented to the data provider (collectively, “promotions”), which are typically encrypted using the data provider's public key. The computation functions may be provided in encrypted or unencrypted form to the network-accessible storage from a function database or service. In one implementation, the computation functions include a number of additions operations and a fixed set of multiplication operations. A communication operation 610 communicates the selected promotion to the data provider in encrypted form, based on the data provider's public key. A decryption operation 612 decrypts the promotion using the data provider's private key.

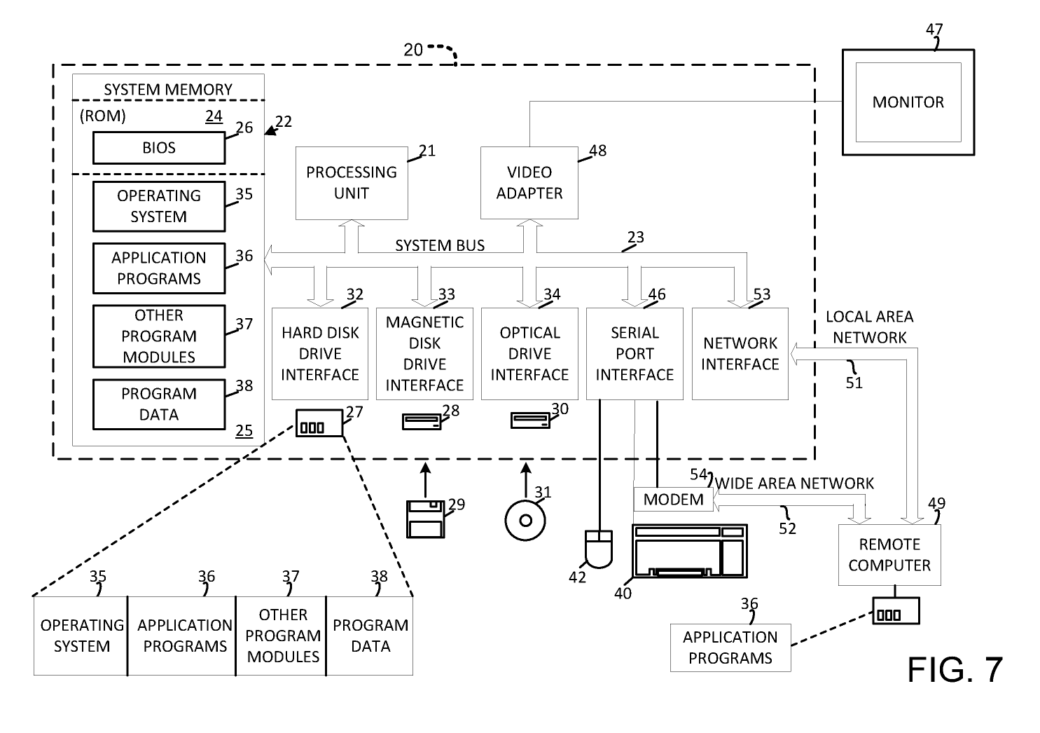

FIG. 7 illustrates an example system that may be useful in implementing the described technology. The example hardware and operating environment of FIG. 7 for implementing the described technology includes a computing device, such as general purpose computing device in the form of a gaming console, multimedia console, or computer 20, a mobile telephone, a personal data assistant (PDA), a set top box, or other type of computing device. In the implementation of FIG. 7, for example, the computer 20 includes a processing unit 21, a system memory 22, and a system bus 23 that operatively couples various system components including the system memory to the processing unit 21. There may be only one or there may be more than one processing unit 21, such that the processor of computer 20 comprises a single central-processing unit (CPU), or a plurality of processing units, commonly referred to as a parallel processing environment. The computer 20 may be a conventional computer, a distributed computer, or any other type of computer; the invention is not so limited.

The system bus 23 may be any of several types of bus structures including a memory bus or memory controller, a peripheral bus, a switched fabric, point-to-point connections, and a local bus using any of a variety of bus architectures. The system memory may also be referred to as simply the memory, and includes read only memory (ROM) 24 and random access memory (RAM) 25. A basic input/output system (BIOS) 26, containing the basic routines that help to transfer information between elements within the computer 20, such as during start-up, is stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program engines and other data for the computer 20. It should be appreciated by those skilled in the art that any type of computer-readable media which can store data that is accessible by a computer, such as magnetic cassettes, flash memory cards, digital video disks, random access memories (RAMs), read only memories (ROMs), and the like, may be used in the example operating environment.

A number of program engines may be stored on the hard disk, magnetic disk 29, optical disk 31, ROM 24, or RAM 25, including an operating system 35, one or more application programs 36, other program engines 37, and program data 38. A user may enter commands and information into the personal computer 20 through input devices such as a keyboard 40 and pointing device 42. Other input devices (not shown) may include a microphone, joystick, game pad, satellite dish, scanner, or the like. These and other input devices are often connected to the processing unit 21 through a serial port interface 46 that is coupled to the system bus, but may be connected by other interfaces, such as a parallel port, game port, or a universal serial bus (USB). A monitor 47 or other type of display device is also connected to the system bus 23 via an interface, such as a video adapter 48. In addition to the monitor, computers typically include other peripheral output devices (not shown), such as speakers and printers.

The computer 20 may operate in a networked environment using logical connections to one or more remote computers, such as remote computer 49. These logical connections are achieved by a communication device coupled to or a part of the computer 20; the invention is not limited to a particular type of communications device. The remote computer 49 may be another computer, a server, a router, a network PC, a client, a peer device or other common network node, and typically includes many or all of the elements described above relative to the computer 20, although only a memory storage device 50 has been illustrated in FIG. 7. The logical connections depicted in FIG. 7 include a local-area network (LAN) 51 and a wide-area network (WAN) 52. Such networking environments are commonplace in office networks, enterprise-wide computer networks, intranets and the Internet, which are all types of networks.

When used in a LAN-networking environment, the computer 20 is connected to the local network 51 through a network interface or adapter 53, which is one type of communications device. When used in a WAN-networking environment, the computer 20 typically includes a modem 54, a network adapter, a type of communications device, or any other type of communications device for establishing communications over the wide area network 52. The modem 54, which may be internal or external, is connected to the system bus 23 via the serial port interface 46. In a networked environment, program engines depicted relative to the personal computer 20, or portions thereof, may be stored in the remote memory storage device. It is appreciated that the network connections shown are example and other means of and communications devices for establishing a communications link between the computers may be used.

In an example implementation, an encryption module, a storage system, a computation system, and other engines and services may be embodied by instructions stored in memory 22 and/or storage devices 29 or 31 and processed by the processing unit 21. Collected data, computation functions, promotions, computation results, public/private keys, and other data may be stored in memory 22 and/or storage devices 29 or 31 as persistent datastores. Example storage, computation, encryption/decryption, and data collection services described may be implemented using a general-purpose computer and specialized software (such as a server executing service software), a special purpose computing system and specialized software (such as a mobile device or network appliance executing service software), or other computing configurations.

The embodiments of the invention described herein are implemented as logical steps in one or more computer systems. The logical operations of the present invention are implemented (1) as a sequence of processor-implemented steps executing in one or more computer systems and (2) as interconnected machine or circuit engines within one or more computer systems. The implementation is a matter of choice, dependent on the performance requirements of the computer system implementing the invention. Accordingly, the logical operations making up the embodiments of the invention described herein are referred to variously as operations, steps, objects, or engines. Furthermore, it should be understood that logical operations may be performed in any order, unless explicitly claimed otherwise or a specific order is inherently necessitated by the claim language.

The above specification, examples, and data provide a complete description of the structure and use of exemplary embodiments of the invention. Since many embodiments of the invention can be made without departing from the spirit and scope of the invention, the invention resides in the claims hereinafter appended. Furthermore, structural features of the different embodiments may be combined in yet another embodiment without departing from the recited claims.

What is claimed is:

1. A method comprising:
storing within network-accessible storage data encrypted using an encryption scheme that allows predictive analysis on the encrypted data without decrypting the encrypted data, the predictive analysis including evaluation of polynomials of bounded degree on elements of the encrypted data, the evaluation including ciphertext addition compositions and a bounded number of ciphertext multiplication compositions;
performing the predictive analysis on the encrypted data stored within the network-accessible storage on the encrypted data to generate encrypted results of the predictive analysis without decrypting the encrypted data; and
transmitting the encrypted results to an entity possessing a decryption key capable of decrypting the encrypted results.

2. The method of claim 1 wherein the stored encrypted data is encrypted using a private encryption key of a data provider.

3. The method of claim 1 wherein the entity possesses the private encryption key of the data provider.

4. The method of claim 1 wherein the stored encrypted data is encrypted using a public encryption key of a results consumer.

5. The method of claim 1 wherein the predictive analysis is defined by computation functions encrypted using the public key of a results consumer.

6. The method of claim 1 wherein the entity possesses the private encryption key of a results consumer.

7. The method of claim 1 wherein the stored encrypted data is encrypted using a public encryption key of a data provider.

8. The method of claim 1 wherein the predictive analysis selects an encrypted promotion as an encrypted result relevant to a data provider based on the stored encrypted data, the encrypted promotion being encrypted using the public key of the data provider.

9. One or more tangible computer-readable storage media storing computer-executable instructions for performing a computer process on a computing system, the computer process comprising:
storing within network-accessible storage data encrypted using an encryption scheme that allows predictive analysis on the encrypted data without decrypting the encrypted data, the predictive analysis including evaluation of polynomials of bounded degree on elements of the encrypted data;
performing the predictive analysis on the encrypted data stored within the network-accessible storage on the encrypted data to generate encrypted results of the predictive analysis without decrypting the encrypted data; and
transmitting the encrypted results to an entity possessing a decryption key capable of decrypting the encrypted results.

10. The one or more tangible computer-readable storage media of claim 9 wherein the evaluation includes ciphertext addition compositions and a bounded number of ciphertext multiplication compositions;

11. The one or more tangible computer-readable storage media of claim 9 wherein the stored encrypted data is encrypted using a private encryption key of a data provider.

12. The one or more tangible computer-readable storage media of claim 9 wherein the entity possesses the private encryption key of the data provider.

13. The one or more tangible computer-readable storage media of claim 9 wherein the stored encrypted data is encrypted using a public encryption key of a results consumer.

14. The one or more tangible computer-readable storage media of claim 9 wherein the predictive analysis is defined by computation functions encrypted using the public key of a results consumer.

15. The one or more tangible computer-readable storage media of claim 9 wherein the entity possesses the private encryption key of a results consumer.

16. The one or more tangible computer-readable storage media of claim 9 wherein the stored encrypted data is encrypted using a public encryption key of a data provider.

17. The one or more tangible computer-readable storage media of claim 9 wherein the predictive analysis selects an encrypted promotion as an encrypted result relevant to a data provider based on the stored encrypted data, the encrypted promotion being encrypted using the public key of the data provider.

18. A system comprising:
network-accessible storage configured to store data encrypted using an encryption scheme that allows predictive analysis on the encrypted data without decrypting the encrypted data, the predictive analysis including evaluation of polynomials of bounded degree on elements of the encrypted data; and
a computation system coupled to the network-accessible storage and configured to perform the predictive analysis on the stored encrypted data to generate encrypted results of the predictive analysis, wherein the encrypted results are transmitted to an entity possessing a decryption key capable of decrypting the encrypted results.

19. The system of claim 18 wherein the received encrypted data is encrypted using a somewhat homomorphic encryption scheme.

20. The system of claim 18 wherein the predictive analysis selects an encrypted promotion as an encrypted result relevant to a data provider based on the received encrypted data, the encrypted promotion being encrypted using the public key of the data provider.
